(19) United States
(12) Patent Application Publication
(10) Pub. No.: US 2024/0117945 A1
(43) Pub. Date: Apr. 11, 2024

(54) LEAK CONTAINMENT SYSTEM WITH INTEGRATED LEAK DETECTION

(71) Applicant: Total Containment Inc., Edmonton (CA)

(72) Inventor: Lawrence Young, Edmonton (CA)

(21) Appl. No.: 18/546,529

(22) PCT Filed: Feb. 18, 2022
(86) PCT No.: PCT/US2022/017106

§ 371 Date: Aug. 15, 2023

Related U.S. Application Data
(60) Provisional application No. 63/151,637, filed on Feb. 19, 2021.

(51) Int. Cl. F17D 5/06; G01M 3/18

(52) U.S. Cl. CPC F17D 5/06; G01M 3/18

(57) ABSTRACT

A system for leak detection and containment is disclosed. The system comprises an impermeable containment casing comprising of a solid extruded material wherein the containment casing encompasses a pipeline deployed therein. The system may further comprise a plurality of separating strips to create an annulus between the pipeline and the containment casing forming one or more flow channels, such that during a leak material leaked from the pipeline flows along a predetermined direction within the one or more flow channels. The containment casing prevents movement of the material leaked from the pipeline to an environment external to the casing. The system may further comprise a plurality of sensors to provide notification of the leak to a user device.

### CROSS-REFERENCE TO RELATED APPLICATIONS

This application claims the benefit of, and priority to U.S. provisional application 63/151,637 titled, “LEAK CONTAINMENT SYSTEM WITH INTEGRATED LEAK DETECTION” filed on Feb. 19, 2021, the entire specification of which is incorporated herein by reference.

### BACKGROUND OF THE INVENTION

### Field of the Art

The disclosure relates to the field of environmental protection, and more particularly to the field of detection and mitigation of risks arising due to pipeline leaks in the environment.

### Discussion of the State of the Art

Leakage or spillage of petroleum products, chemicals, hazardous substances, and wastes poses a significant threat to workers, the workplace, and the environment. Consequently, efforts have been made by petroleum industry workers, sanitation workers, chemical industry workers, transportation industry workers, military personnel, and other workers involved in liquid and gas containment to guard against environmental contamination resulting from undesired release into the environment of various liquids, gases and chemicals.

In particular, pipeline companies often cooperate with local emergency responders along pipeline right-of-way and work with and often train with fire departments or hazardous materials units for the mitigation of spills and other faults with energy transmission via pipelines. Pipelines may be positioned underground, carrying highly pressurized materials for decades. However, pipelines may break for many reasons including, for example, corrosion, equipment or weld failures, construction workers hitting pipes with their excavation equipment, and/or unforeseen natural disasters. Further, following a spill, it is tremendously expensive to clean and remediate the environment. Antiquated pipes, minimal oversight, and inadequate precautions put the public and the environment at increasing risk.

Various approaches to solving this problem have involved using tougher, puncture-proof steel for the pipeline; designing protective jackets around the pipeline; applying epoxy coatings to the pipeline; modifying the wall thickness of the pipeline; and using inspection, surveillance, and monitoring equipment in order to inspect the wall thickness, welds, and integrity of the pipeline; expedite response to a spill and/or release; and minimize the danger and damage once a spill or release has occurred. However, inspection, surveillance, and monitoring does not effectively prevent the leaking material from being released into the environment. Safety and health regulations require secondary containment to be utilized for storage containers (e.g., drums, tanks, totes) which hold materials such as petroleum products, chemicals, hazardous substances, and wastes. Secondary containment protects not only the environment from contamination but also employees working in areas where such materials are stored and used. However, secondary containment is lacking for pipelines in conventional pipeline transportation systems.

Accordingly, there remains a need in the art for ways to contain spills and releases from pipelines to mitigate these problems.

### SUMMARY OF THE INVENTION

Accordingly, the inventor has conceived and reduced to practice, in a preferred embodiment of the invention, a leak containment system with integrated leak detection. The current invention is designed to provide a leak containment system for mitigating risks associated with leaks in pipelines that can direct flow from a leak in a pipeline, along the pipeline itself. In a preferred embodiment, the containment system may be installed on a section of pipe in an extrusion or injection molding process plant or created separately and mounted to an existing pipeline and can be installed on a section of pipeline or an entire pipeline depending on various applications of the pipeline.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 illustrates a pipeline installed with a pipeline containment system, according to an embodiment of the present invention.

FIG. 2 is an expanded view of a pipeline containment system illustrating one or more components of the pipeline containment system, according to an embodiment of the invention.

FIG. 3 is a front view of a pipeline installed with the pipeline containment system illustrating one or more flow channels, according to an embodiment of the invention.

FIG. 4 is a front view of a flow gasket provided for creation of the one or more flow channels, according to an embodiment of the invention.

FIG. 5 is a top view of an outer jacket joint for a pipeline containment system, according to an embodiment of the invention.

FIG. 6 is a cross-sectional side view of a pipeline installed with pipeline containment system, according to an embodiment of the invention.

FIG. 7 is another cross-sectional side view of a pipeline installed with the pipeline containment system, according to an embodiment of the invention.

FIG. 8A illustrates an exemplary sewage pipeline with a containment system, in accordance with an embodiment of the invention.

FIG. 8B illustrates an exemplary sinkhole detection system using a containment system, in accordance with an embodiment of the invention.

FIG. 8C illustrates pipeline in a subsea environment, according to an embodiment of the invention.

### DETAILED DESCRIPTION

In a preferred embodiment of the invention, the inventor has conceived and reduced to practice a leak containment system with integrated leak detection.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a,” “an,” and “the” include plural referents unless the context clearly dictates otherwise.

The present invention relates to systems and methods for secondary containment for a material conveyed by pipeline transport.

As used herein, the term “secondary containment” may refer to a control measure placed around or otherwise surrounding a pipeline to prevent a material contained therein from spillage causing subsequent pollution of the environment in the vicinity of the pipeline. As used herein, the term “contain” may refer to constraining a material within limits. As used herein, the term “environment” may comprise soil, groundwater, surface water, natural earthen materials, air, and the like. The material may be flammable, hazardous, and/or corrosive.

As used herein, the term “pipeline” may refer to a pipe used to convey a material such as fluids, gas, sludge, products, or a combination thereof, wherein the term may further comprise installations associated with the pipeline.

As used herein, the term “material” may refer to any gaseous, semi-solid, liquid or liquid-like substance including, but not limited to, crude oil (petroleum), refined oil products (petroleum products derived from crude oil such as fuel oil, kerosene, gasoline, and diesel oil), natural gas products, sludge, sewage, oil refuse, oil mixed with wastes, oils or greases of animal, fish or marine origin, vegetable oils, synthetic oils, mineral oils, chemicals, salt water, wastewater, carbon, hydrogen, and the like.

As used herein, the term “trench” may refer to any elongate excavation or depression formed in the ground. The term may comprise a trench which is either “open” (e.g., in the form of an exposed ditch or trough dug into the surface of the ground), or “closed” (e.g., in the form of an enclosed underground tunnel or conduit).

As used herein, the term “engineered material” may refer to any material capable of diffusing energy from a leak and being porous enough to allow the flow of air/gas or liquid, a fluid either alone or in combination with soil, sand, aggregate material, and the like.

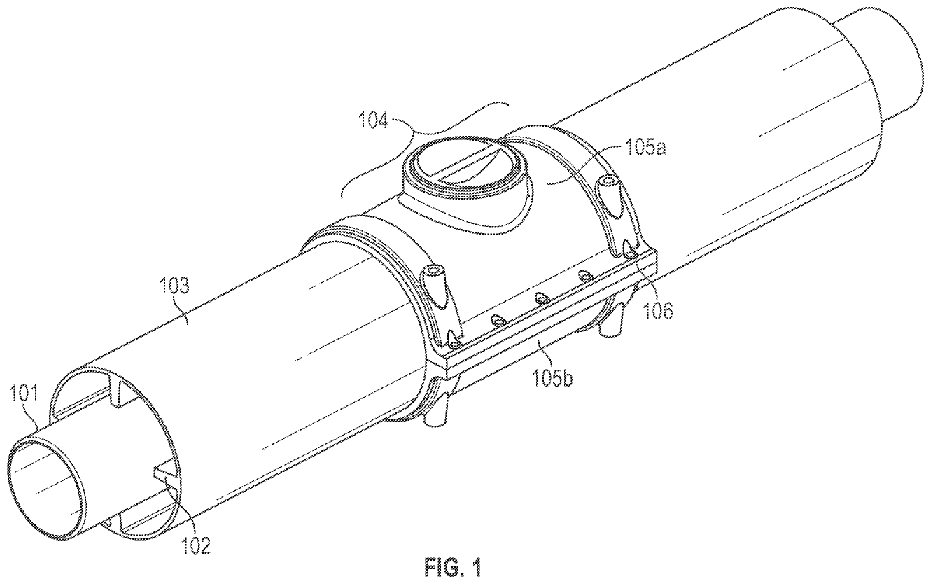

The invention will now be described having reference to the accompanying Figures Typically, pipelines can be built for use above or below the surface of the ground for temporary or permanent use. As shown in FIG. 1, the present invention may be used in the context of a pipeline 101 which is positioned within a conventional pipeline trench (not shown) below ground surface. In an embodiment, pipeline 101 may also be positioned above the ground level. For positioning pipeline 101 below the ground level, the engineered material may be used as backfill. Further, in some embodiments, the engineered material may be formed of a stable malleable material such that the engineered material may be unaffected by erosion. In such an arrangement, a containment system 100 to be installed within the trench to avoid bulging of pipeline 101. In an embodiment, pipeline 101 may be constructed using materials such as, but not limited to cast iron, galvanized iron, wrought iron, steel, copper, plastic, composite material, or a combination thereof.

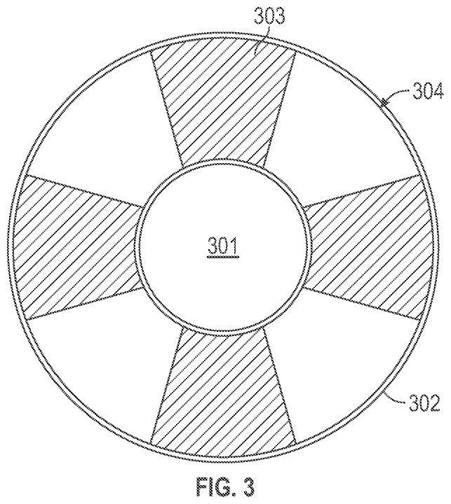

In an embodiment, a plurality of separating strips 102 are installed along an entire length of pipeline 101. In the embodiment, the plurality of separating strips 102 may be extruded onto pipeline 101 as individual strips such that one or more channels are created for flow of material in an instance of leakage of the material transported using pipeline 101 (as detailed in FIG. 3). In an embodiment, the plurality of separating strips 102 may be constructed using materials such as High-density polyethylene (HDPE), Polyvinyl chloride (PVC), or other suitable material used individually or in combination.

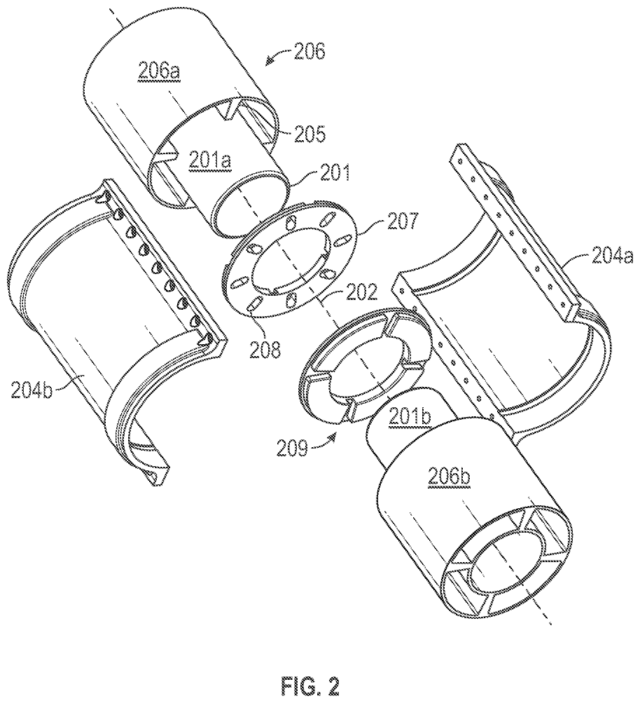

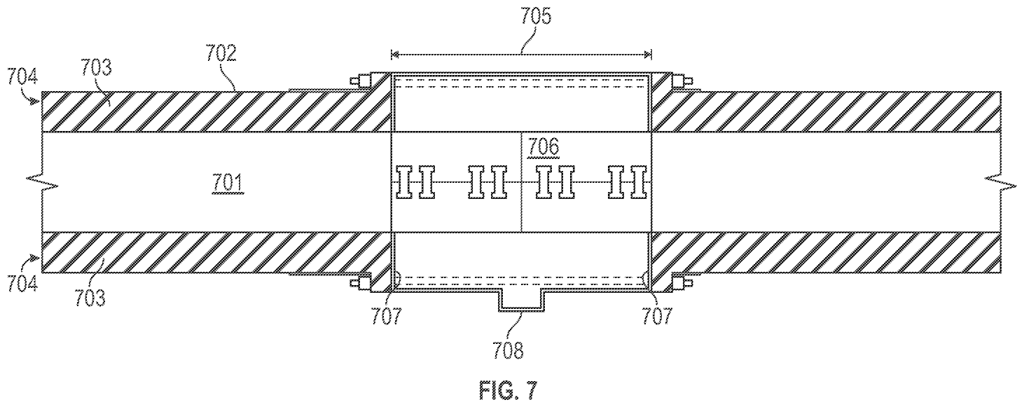

In an embodiment, one or more separating strips 102 may be extruded on pipeline 101 as multiple strips with varying degrees of offset from each other. According to the embodiment, each of the one or more separating strips 102 may be extruded onto pipeline 101 in a straight line running horizontally along pipeline 101 (as detailed in FIGS. 2 and 7). In another embodiment, each separating strip 102 is placed onto pipeline 101 in a wrapping formation such that the one or more channels are created in a “swirling” formation around pipeline 101, inside a containment casing 103, so as to direct a flow of material leaked from pipeline 101 horizontally along pipeline 101, whilst keeping the leaked material contained within containment casing 103. This may advantageously ensure that leaked material from pipeline 101 does not seep into the environment thereby mitigating the risks of environmental pollution or lost product.

As shown in FIG. 1, containment casing 103 is detachably attached to each separating strip 102 without being attached directly to pipeline 101. Such a connection between the separating strips 102 and containment casing 103 may be designed so as to create an annulus between containment casing 103 and each separating strip 102, so as to allow for leaking material from pipeline 101 to flow along the length of pipeline 101, without coming in contact with the environment surrounding pipeline 101.

Containment casing 103, in construction, is built as one or more individual sections that may be combined (on-site or off-site) to form the complete containment casing 103 (shown in FIG. 2). Each of the one or more individual sections of containment casing 103 may be of a larger diameter than that of pipeline 101 to create the annulus between pipeline 101 and containment casing 103. Further, each individual section of containment casing 103 may terminate at a fix distance from a termination point of an individual section of pipeline 101 to allow an outer jacket joint 104 to be installed over containment casing 103 (detailed in FIG. 7).

In one embodiment, containment casing 103 may be created by an extrusion process, as dictated by various operator preferences and/or applications of pipeline 101. In another embodiment, containment casing 103 may be formed using one or more of HDPE, PVC, thermoplastics, recycled materials such as rubber or plastic, and the like. Suitable construction of containment casing 103 may be done so as to ensure impermeability as well as strength to withstand internal forces from areas where pipeline 101 has been installed.

In an embodiment, the outer jacket joint 104 may comprise of first clamp 105a and second clamp 105b fixed onto containment casing 103, as shown in FIG. 1.

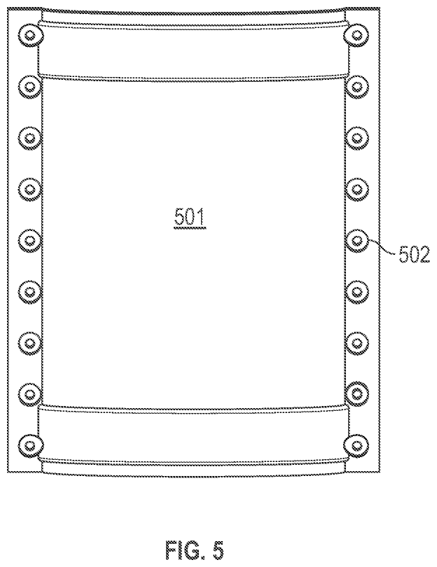

In one embodiment, outer jacket joint 104 may be fixed onto a section of containment casing 103 using bolts 106, however in alternate embodiments, outer jacket joint 104 may also be fixed using one of flanges, gaskets, or other suitable connection means. Outer jacket joint 104 is described in detail with reference to FIG. 5.

FIG. 2 illustrates one or more components of containment system 200, in accordance with an embodiment of the present invention. As shown in the figure, pipeline 201 may comprise of individual sections 201a and 201b, such that each end of individual sections may be welded together, in order to warrant flow of material being transported within pipeline 201 in a single flow direction, as depicted by dotted line 202. In an embodiment, pipeline 201 may be constructed in a manner that multiple individual sections of pipeline 201 may be of specific lengths. Further, two individual sections of pipeline 201 may be welded or fitted together at their respective termination points and a welded joint (not shown) may be covered using outer jacket joint 203 using first clamp 204a and second clamp 204b.

In a preferred embodiment, the inside of outer jacket joint 203 may be void of any material except for a sensor unit (not shown) that may be installed at the bottom of the outer jacket joint 203, comprising of one or more sensors to detect leakages and collect data associated with pipeline 201. The welded individual sections of pipeline 201 and the sensor unit within outer jacket joint 203, are described in further detail with reference to FIG. 7.

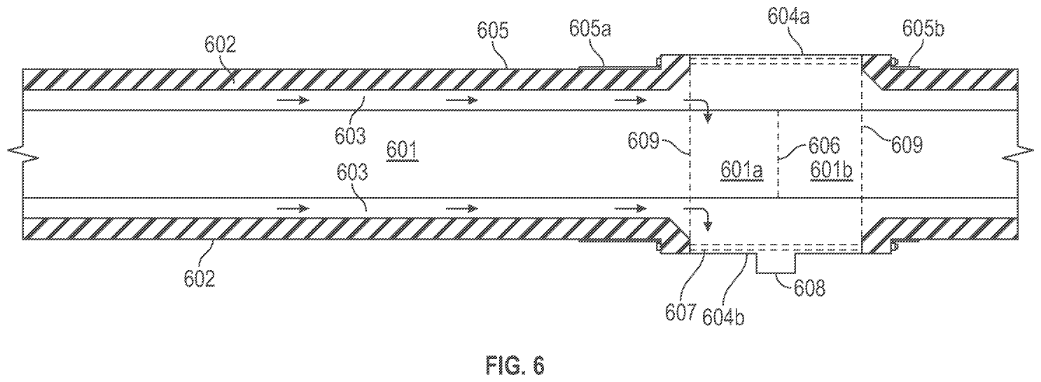

Further, a plurality of separating strips 205, extruded onto a length of pipeline 201 and further attached to containment casing 206 may enable creation of an annulus throughout the length of pipeline 201. As shown in FIG. 2, each of the plurality of separating strips 205 surrounding pipeline 201, may create the annulus thereby generating a flow channel to allow flow of leaked material from pipeline 201 into an inside of outer jacket joint 20, whilst being contained within containment casing 206. Such a flow of leaked material is described in greater detail with respect to FIG. 6 and FIG. 7.

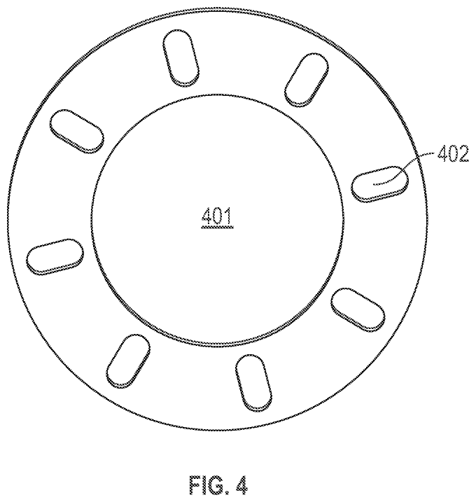

In an embodiment, flow gasket 207 may be attached to an end point of individual section 206a of containment casing 206 in a direction of flow of the material within pipeline 201. As depicted, flow gasket 207 may comprise of a plurality of overflow holes 208 carved over a surface of flow gasket 207, to allow for leaked material from pipeline 201 to flow from the flow channel, created by the plurality of separating strips 205, and accumulate within the empty space created by outer jacket joint 203. An exemplary flow gasket is described in detail with respect to FIG. 4.

In an embodiment, to ensure that the leaked material is collected within the empty space formed by outer jacket joint 203, secondary gasket 209 may be attached to opposing individual section 206b of containment casing 206. According to the embodiment, secondary gasket 209 is similar to dimension and structure to flow gasket 207, with the exception of overflow holes 208. Such a structure of secondary gasket 209 may ensure that the leaked material is entrapped within an empty space created by outer jacket joint 203 covering the welded joint of individual sections of pipeline 201 and does not perforate in the surrounding environment.

In an embodiment, flow gasket 207 and secondary gasket 209 may be attached using flanges, bolts, or any other suitable connection means to each end point of respective individual sections of containment casing 206. Further, in an embodiment, flow gasket 207 and secondary gasket 209 may be one of envelope gaskets (double jacketed gaskets), flat metal gaskets, non-asbestos sheet material gaskets, ring type joint, Kammprofile™ gasket, spiral wound gaskets with an inner ring, spiral wound gaskets without an inner ring, or corrugated metal gaskets, depending on a type of pipeline 201 and applications of pipeline 201.

In several embodiments, containment casing 206 may be installed onto pipeline 201 (pre-installed) in one or more separate pieces on either side of pipeline 201 to encompass pipeline 201. In other embodiments, containment casing 206 may be installed vertically to encompass pipeline 201 in the form of top and bottom pieces. In each of the above embodiments, containment casing 206 may be pre-manufactured complete with the plurality of separating strips extruded thereon. Each completed individual section (e.g., sections 206a and 206b) of containment casing 206 may be installed such that an end point of the individual section of containment casing 302 and a termination point of an individual section of pipeline 201 are spaced at least a predetermined distance from one another to allow for mechanical welding of two individual sections (e.g., sections 201a and 201b) of pipeline 201. The predetermined distance, in an embodiment, may be 30.48 cm (12 inches). Further, the predetermined distance, in one or more embodiments, may be set specifically for one or more applications of pipeline 201.

FIG. 3 illustrates a front cross section view of a pipeline 301, according to an embodiment of the invention. As depicted in the figure, pipeline 301 is surrounded by containment casing 302. Pipeline 301, in an embodiment, may have a diameter ranging from 12.7 mm to 1524 mm (0.5 inches to 60 inches). In some embodiments, pipeline 301 may be buried inside a trench (not shown) at a depth of about 0.9 m to 1.8 m (3 to 6 feet). In other embodiments, specifically for off-shore applications, pipeline 301 may be buried deeper than 1.8 m, such as in an approach to a river or a road.

In an embodiment, containment casing 302 may be attached to a plurality of separating strips 303 using processes such as extrusion and injection molding. In some embodiments, containment casing 302 may be extruded onto separating strip 303 using one of a cold extrusion process, a hot extrusion process, a friction extrusion process, or a micro extrusion process. In other embodiments, containment casing 302 may be injected onto separating strip 303 using one of cube molding, die casting, gas-assisted injection molding, liquid silicone rubber injection molding, metal injection molding, micro injection molding, reaction injection molding, thin-wall injection molding, and the like.

In an embodiment, each of the plurality of separating strips 303 may be extruded or injected onto a surface of pipeline 301. In another embodiment, each of the separating strips 303 may have a width ranging from 12.7 mm to 1524 mm 0.5 inches to 24 inches depending upon the size of pipeline 301. For most general applications of pipeline 301, a width of each separating strip 303 may lie between 5.08 cm to 30 cm (2 inches to 12 inches). Further, height of the annulus created by installation of the plurality of separating strips 303 may range between 12.7 mm to 1524 mm (0.5 inches to 6 inches) in dimension. That is, the distance between the surface of pipeline 301 and inner wall 304 of containment casing 302 may range between 12.7 mm to 1524 mm (0.5 inches to 6 inches). Further, in other embodiments, the width and height of the separating strips 303, and therefore the distance between the surface of pipeline 301 and inner wall 304 of containment casing 302 may be varied to address various applications and conditions of pipeline 301.

As shown in FIG. 3, one or more channels 305 created between two separating strips 303 may allow for any leaked material from pipeline 301 to flow in a direction parallel to pipeline 301 inside the annulus, between pipeline 301 and containment casing 302. In an embodiment, a thickness of containment casing 302 may range between 0.31 cm to 0.25 cm (one-eighth to one-tenth of an inch) for general applications of pipeline 301, however, the thickness may approach or exceed to a predefined dimension, e.g., 5.08 cm (2 inches), based on one or more specific applications of pipeline 301 and depending on pressures associated with the material being transported using pipeline 301.

In a preferred embodiment, each of the plurality of separating strips 303 may be in contact with an outer surface of pipeline 301 so as to ensure that crushing or destruction of containment casing 302 may be avoided during backfilling of pipeline 301 or from the hydrostatic pressures experienced during a sub-sea installation of pipeline 301. Further, containment casing 302, in an embodiment, may be extruded with the plurality of separating strips 303 and installed on-site for pipeline 301. In the embodiment, the installation may include sealing containment casing 302 to pipeline 301 using electrofusion welding, chemical adhesion, clamping, or any other suitable method.

FIG. 4 is a front view of a flow gasket provided for creation of the one or more flow channels for movement of leaked material, according to an embodiment of the invention.

As shown, flow gasket 401 is manufactured as a mechanical seal which may fill a space between two individual sections of a containment casing (as shown in FIG. 2). In an embodiment, flow gasket 401 comprises a plurality of overflow holes 402, each allowing a flow of material leaked from a pipeline, from one or more channels created using a plurality of separating strips, as described in the foregoing. Flow gasket 401 may be attached to an end point of an individual section of containment casing 103, such that the individual section of containment casing 103 may be connected to another individual section of containment casing 103 through a secondary gasket using flanges, bolts, or other connection means. In an embodiment, flow gasket 401 may be manufactured by punching, water jet cutting, laser cutting, hand cutting, strip cutting, and the like.

FIG. 5 illustrates a clamp used to create an outer jacket joint installed for a pipeline containment system, according to an embodiment of the invention.

The figure depicts clamp 501 that may be installed encompassing an upper outer wall of containment casing 103, according to one embodiment of the invention. According to the embodiment, clamp 501 may comprise of a plurality of clearance holes 502 to accommodate a plurality of bolts (not shown) to enable affixing of clamp 501 with a second clamp 501 (as shown in FIG. 1) to complete the outer jacket joint. In an embodiment, the plurality of clearance holes 502 may comprise of threaded bores and may the size of each clearance hole may be determined based on the size of bolts and screws required to connect the two clamps together. Further, clamp 501 may be made of plastic, metal, HDPE, a combination thereof or another material.

In a preferred embodiment, each clamp 501 may be attached to another clamp 501 in a manner that leaked material from pipeline does not perforate to the exterior environment surrounding pipeline. Further, the shape and dimensions of the clamp may be selected based on the dimensions of containment casing 103, to ensure that the outer jacket joint 104 (as shown in FIG. 1), when created using the two such clamps, may completely cover a welded joint of pipeline (not shown), whilst creating an empty space to house the sensor unit (not shown). The welded joint and the sensor unit are described in detail in FIG. 6.

FIG. 6 is a cross-sectional side view of pipeline installed with a pipeline containment system, according to an embodiment of the invention.

According to the embodiment, pipeline 601 is installed with a plurality of separating strips 602, thereby creating one or more flow channels 603 to allow for flow of leaked material from pipeline 601 into an empty space created by a first clamp 604a and a second clamp 604b. In an embodiment, each separating strip 602 may be extruded or injection molded to pipeline 601 during installation of pipeline 601.

Further, each separating strip 602 may be attached to containment casing 605 using solid extruded material such as HDPE, PVC, plastic, or a combination thereof. Such a connection of a separating strip 602 to containment casing 605, is described in greater detail in FIG. 7. Individual sections 605a and 605b of containment casing may be connected with the one another using flow gaskets (not shown) or a combination of flow gaskets and secondary gaskets on either sides (not shown), described in the foregoing and depicted herein using the vertical dotted lines 609.

Furthermore, an individual section of pipeline 601a may be connected to another corresponding individual section 601b, using mechanical welding at welding joint 606. According to an embodiment, an outer jacket joint (not shown) comprising of the first clamp 604a and a second clamp 604b (each bolted to containment casing 605 using multiple bolts 607) may encompass pipeline 601 at the welding joint 606 to create an empty space to allow leaked material from one or more flow channels 603 to enter and come in contact with a sensor unit 608. The direction of movement of the leaked material from pipeline 601 is as shown by bolded arrows.

In a particular embodiment shown in FIG. 6, each individual section of containment casing 605 may comprise of flow gaskets (not shown) to allow for leaked material to flow within the empty space, both along the direction of material flowing in pipeline 601 as well as against the direction of flow of material within pipeline 601, as shown. A person skilled in the art would however appreciate that in alternate embodiments, the flow of leaked material into the empty space could be restricted using a secondary gasket (not shown), to either along the direction of material flowing in pipeline 601 or against the direction of flow of material within pipeline 601 (as described in FIG. 2).

As shown in FIG. 6, once the leaked material flows from one or more flow channels 603, it may come in contact with sensor unit 608. In one embodiment, sensor unit 608 may be housed within the outer jacket joint via one or more ports or other accessible areas (not shown) to allow each sensor to be changed, recharged, or tested as and when necessary. Further, the outer jacket joint may also provide for egress for any electronic connections or wires to be connected from outside of containment system 600 to sensor unit 608. In an embodiment, the one or more ports may also hold gateway or communication devices to gather data from one or more devices operating inside the annulus created between pipeline 601 and containment casing 605.

In an embodiment, sensor unit 608 may comprise a sensor array, including fiber optic cables, wall thickness instruments, pressure sensors, accelerometers, and the like for detection of leaks or ingress into the one or more flow channels 603 and to assist in monitoring the health of pipeline 601.

FIG. 7 illustrates another cross-sectional side view of a pipeline installed within a pipeline containment system, according to an embodiment of the invention.

As shown, pipeline 701 is surrounded by containment casing 702 such that an annulus between pipeline 701 and containment casing 702, using one or more separating strips 703, creates one or more separator channels 704 for flow of material leaked from pipeline 701. According to an embodiment, an outer wall of containment casing 702 may further be attached to outer jacket joint 705, wherein outer jacket joint 705 is made up of two separate clamps (as shown in FIG. 2) bolted together to cover welded joint 706 of pipeline 701.

In an embodiment, outer jacket joint 704 is detachably connected to containment casing 702 using a plurality of flange connections 707, as depicted. Further, outer jacket joint 704 is installed in a manner that an empty area is created above and below welded joint 706. The empty area may be void of any material, except for sensor unit 708, and allow seeping of leaked material therein from the one or more separator channels 704. Sensor unit 708 may form a leak detection mechanism for pipeline 701. The leak detection mechanism and containment casing 702 may thereby enable safe, autonomous, and timely detection of leaks from pipeline 701 without seepage of the material in an environment surrounding pipeline 701.

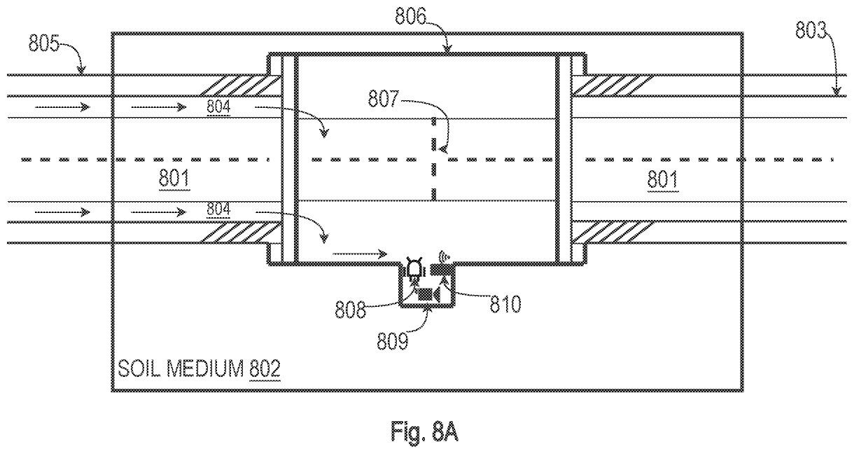

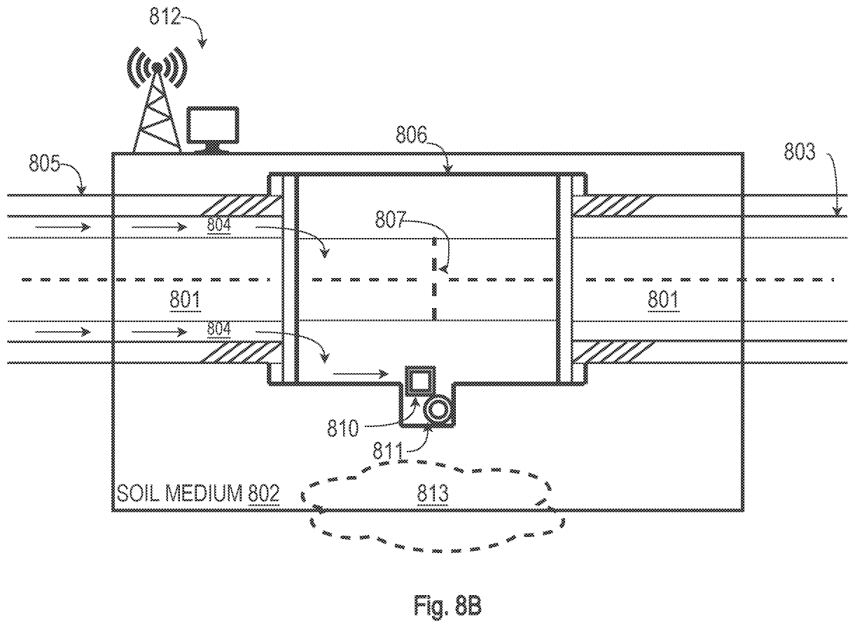

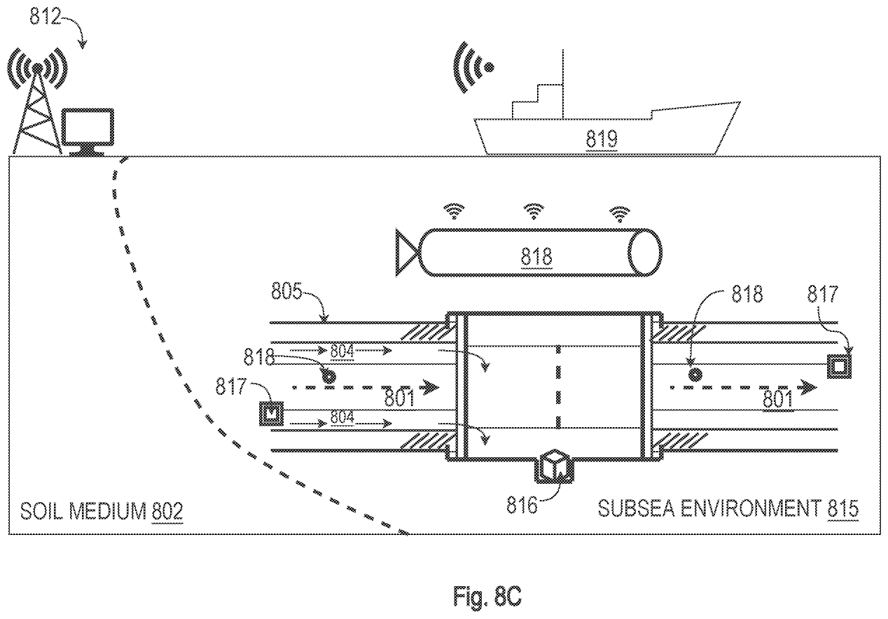

In several embodiments of the present invention, the containment system described herein can be used on any horizontal and vertical pipeline and/or telecommunication corridors for leak containment and detection. Further, the systems and methods described herein can be used as a means of delivering multiple materials, simultaneously, or delivering and removing materials simultaneously through pipelines of any shape, size, or dimension based on specific applications. In some embodiments, the containment system described herein may be used for pipeline leak containment with monitoring and detection. Similarly, other embodiments may include using such containment systems for pipelines for the simultaneous delivery or removal of materials through a wellhead. In another embodiment, one or more secondary pipes may be grouped together in the annulus created between the pipeline and the containment casing, e.g., for creation of a telecommunication corridor and/or a fiber optic network. Other embodiments may include leak detection and mitigation in sewage pipelines, water or other materials transported using pipelines in subsea environments, or detection and reporting of underground sinkhole formations. Some of these embodiments have been detailed in FIGS. 8A-8C.

FIG. 8A illustrates an exemplary sewage pipeline with a containment system, in accordance with an embodiment of the invention. As shown in the figure, pipeline 801 may be a sewage pipeline containing waste material from several sewage lines to waste treatments plants. In an embodiment, pipeline 801 may be installed underground, e.g., through a soil medium 802.

Leaks in sewage pipes, such as pipeline 801, cause significant concerns to water management authorities around the world. Leaks in sewers and water pipes can cause a variety of problems, such as contamination of drinking water, groundwater pollution, and land subsidence. Many administrative bodies are investing a significant amount of money for the prevention and management of possible impacts from leakage of sewage pipelines. These issues further aggravate infrastructure and the conditions, thereby creating hindrance in socio-economic activities. The aftermath of such pipeline leaks may cause subsidence and sinkholes in the soil that these pipelines are installed in. This may further lead to damage roads, highways, railroads, underground liquid transport network, flora, and fauna.

In an embodiment depicted in FIG. 8A, pipeline 801 carrying sewage and/or other waste material may be installed with one or more separating strips 803, such that installation of each separating strip 803 may create flow channels 804 for movement of leaked sewage material from pipeline 801 towards a plurality of sensors, as depicted using arrows. According to the embodiment, the leaked sewage and other waste material does not permeate into soil medium 802 due to containment casing 805 connected to each of the one or more separating strips 803 and encompassing pipeline 801 in its entirety. Further, containment casing 805 may be connected to a jacket joint 806 that houses the plurality of sensors (not shown) and covers welded joint 807 of two individual sections of pipeline 801. Such an arrangement may ensure that each welded part of pipeline 801 may be securely covered with protective covering in the form of jacket joint 806 whilst ensuring that leaked sewage material from pipeline 801 comes in contact with the plurality of sensors in a quick turnaround time, thereby reducing the time for leak detection.

In an embodiment, the plurality of sensors may comprise, at least, robotic sensor 808, camera 809, and mobile sensor 810. According to the embodiment, a combination of the robotic sensor 808, camera 809, and mobile sensor 810 monitoring pipeline 801 to overcome spillage issues associated with pipeline 801. Robotic sensor 808 may initialize camera 809 to capture the images of pipeline 801 interiors, and corresponding image data may be transmitted via a communication network for detailed visual inspection, as shown. Further, mobile sensor 810 may be capable of moving in a linear direction with wireless cameras (not shown) installed on an outside surface of the mobile sensor 810, such that mobile sensor 810 may be used to inspect existence of any leakages, cracks, fissures, and other damages to pipeline 801, even before sewage material is transported using pipeline 801.

In one or more embodiments, a combination of robotic sensor 808, camera 809, and mobile sensor 810 may advantageously enable monitoring each individual section of pipeline 801. Further, prevention of sewage seeping into soil medium 802 may also be realized using containment casing 805, thereby creating a containment system for use before, during, and after transportation of material using pipeline 801.

FIG. 8B illustrates an exemplary sinkhole detection system using a containment system, in accordance with an embodiment of the invention. As shown in the figure, pipeline 801 may be a pipeline conveying material from a source to a destination. In an embodiment, pipeline 801 may be installed underground, e.g., through soil medium 802, wherein sinkhole 813 may be present.

Sinkhole may refer to an underground cavity formed by underground erosion and surface depression. Generally speaking, there may be two types of sinkholes—natural and man-made. Natural sinkholes are mainly found in areas with high deposits of salt, limestone, and carbonate rocks. Precisely predicting where and when these sinkholes will occur is quite difficult. Groundwater abstraction, construction in adjoining areas, and leakage of underground pipelines are the main reasons for the formation of man-made sinkholes in urban areas. Of these, leaks, bursts, or blockages in sewers, drains, and/or water supply lines are the most commonly reported causes of sinkholes. In recent years, with the continuous acceleration of urbanization and the continuous construction, development and expansion of urban areas, the problem of sinkhole creation has been escalating globally.

As shown in the figure, sinkhole 813 may begin to form as some portion of medium 802 (surrounding pipeline 801) melts. This reduces the carrying capacity of the soil layer above sinkhole 813, and therefore the soil collapses to form a vortex. The size of such cavities may range from 2 meters deep and 1.5 meters wide to an enormous scale to 15 meters deep and 30 meters wide, as reported in various countries across the world. These incidents are reported to have caused significant economic damage and loss of life. In a specific town in the United States, it was reported that 22 houses had been destroyed because of the sudden collapse of a 44-year-old sewage pipeline, and the reconstruction of the damaged road and sewage pipelines cost the city approximately $70 million in repair costs. Further, in the United States alone, more than 20 ground failures were observed due to the failure of underground pipelines. The risk of sinkhole creation has increased because of various ground subsidence phenomena.

The containment system shown in FIG. 8B is related to a safety monitoring system for pipeline 801, wherein a sensor unit comprising of position sensor 810 and accelerometer 811 may be attached to pipeline 801. Accordingly, position sensor 810 may generate a position change signal and the accelerometer 811 may generate vibration signals at regular intervals in accordance with material flow inside pipeline 801 and transmit signals to monitoring station 812 situated at ground level, to detect leakage in pipeline 801. The advantage of the sensor unit is that it can detect changes in vibration pattern and position due to changes in flow velocity when pipeline 801 is affected (for example, bent, broken, or some other damage). Further, due to the installment of containment casing 805 as well as jacket joint 806, it may be ensured that leaking material does not seep into the environment, thereby avoiding further worsening of the soil medium due to the sinkhole. That is, sensors 810 and 811 along with containment casing 805 may provide adequate mechanism for not only providing timely detection and prevention of leakage of material from pipeline 801, but also aid in detecting existing sinkholes in soil medium 802, even after pipeline 801 has been installed.

FIG. 8C illustrates pipeline in a subsea environment, according to an embodiment of the invention.

Water is necessary for human survival. About 71% of the world is covered with water, of which only 2.5% is freshwater which is available for human consumption. Millions of kilometers of pipelines are currently in operation around the world to transport vast amounts of freshwater. For example, in the Kingdom of Saudi Arabia, hundreds of kilometers of underground pipelines have been laid to connect cities and the Arabian Gulf through the desert. Unfortunately, according to the World Bank, the actual non-revenue water (NRW) levels (water losses) in developing countries are estimated to be in the range of 40-50% of the fresh water produced.

According to statistical analysis, large pipelines will experience at least one obvious leak each year. These pipelines are exposed to multiple hostile environmental factors that can damage the pipeline, such as extreme soil conditions, aging materials, beds, and excessive force. Pipeline leaks, coupled with environmental pollution, can result in significant excess costs due to reparations and damage to infrastructure. Therefore, the security and maintenance of the pipeline infrastructure is one of the main concerns.

In the embodiment, shown in FIG. 8C, pipeline 801 may be a pipeline installed underwater, i.e., in a subsea environment 815. According to the embodiment, various a sensor unit 816 may be connected wirelessly or through wired connections to various types of sensors (not shown) for monitoring of pipeline 801. These sensors may include static sensors 817 that may be fixed on an outer surface of pipeline 801 and used to sense real-time data about one or more resources associated with pipeline 801.

The types of sensors may further comprise mobile sensors 818 that may simply move inside pipeline 801 along with the conveyed material in a direction as depicted by the dotted line. The mobile sensors 818 may be placed inside pipeline 801 from a source point and continue to a sink point, where information stored in the mobile sensor's 818 memory may be transmitted through sensor unit 816 to monitoring station 812. This information may include location information.

In another embodiment, the sensors may include an automotive vehicle 819 that may be configured to repair damaged segments, as well as collect observations from static and mobile sensors and relay said observations to a large vessel 819 to a crew of operators and/or remotely to the monitoring station 812.

The advantage of the sensor unit 816 is that it can detect changes in operations of pipeline 801. Further, due to the installment of containment casing 805 as well as jacket joint 806, it may be ensured that quick and clear water leakage detection, even under subsea environment 815, may be realized. That is, the sensor unit 816 along with containment casing 805 may provide an adequate mechanism for timely detection and prevention of leakage of water from pipeline 801, thereby preventing loss of drinkable treated water as well saving on operation costs for pipeline 801.

What is claimed is:

1. A leak detection and containment system comprising:
an impermeable containment casing comprising of a solid extruded material, wherein the containment casing encompasses a pipeline deployed therein;
a plurality of separating strips, each affixed to an outer wall of the pipeline and detachably connected to the containment casing;
wherein each of the plurality of strips creates an annulus between the outer wall of the pipeline and the containment casing thereby forming one or more flow channels;
wherein during a leak, material leaked from the pipeline flows along a predetermined direction within the one or more flow channels;
wherein the containment casing prevents movement of the material leaked from the pipeline to an environment external to the containment casing.

2. The system of claim 1 further comprising a plurality of sensors to receive the material leaked from the pipeline through the one or more flow channels and provide a notification of the leak to a user device.

3. The system of claim 2, further comprising an outer jacket joint to house the plurality of sensors, wherein the outer jacket joint comprises of a first clamp and a second clamp.

4. The system of claim 3, wherein the outer jacket joint covers a welded joint between two individual sections of the pipeline such that a connection of the first clamp and the second clamp creates an empty space around the welded joint of the pipeline encompassed within the connection.

5. The system of claim 1, wherein a first section of the containment casing is connected to a second section of the containment casing using a first gasket and a second gasket, and wherein the first gasket is detachably connected to a termination point of the first section and the second gasket is detachably connected to a termination point of the second section.

6. The system of claim 5, wherein the first gasket comprises of a plurality of overflow holes on an outer surface.

7. The system of claim 5, wherein the first gasket and the second gasket each comprise a plurality of overflow holes on respective outer surfaces.

8. The system of claim 6, wherein the termination point of the first section of the containment casing and an end point of an individual section of the pipeline are spaced at least a predetermined distance from one another.

9. The system of claim 1, wherein one or more separating strips are extruded on the pipeline as multiple strips with predefined degrees of offset from one another.

10. The system of claim 1, wherein each separating strip is extruded onto the pipeline in a straight line running horizontally along the outer wall of the pipeline

11. The system of claim 1, wherein each separating strip is placed onto the pipeline in a wrapping formation such that the one or more flow channels are created in a swirling formation around the pipeline.
